(19) United States
(12) Patent Application Publication
(10) Pub. No.: US 2017/0132382 A1
(43) Pub. Date: May 11, 2017

(54) METHOD FOR DETERMINING PROGRAMMATICALLY EXPECTED DISEASE RECURRENCE LIKELIHOOD

(71) Applicant: UNIVERSITY OF IOWA RESEARCH FOUNDATION, Iowa City, IA (US)

(72) Inventor: Donghai Dai, Iowa City, IA (US)

(73) Assignee: UNIVERSITY OF IOWA RESEARCH FOUNDATION, Iowa City, IA (US)

(21) Appl. No.: 15/346,489

(22) Filed: Nov. 8, 2016

Related U.S. Application Data
(60) Provisional application No. 62/252,827, filed on Nov. 9, 2015.

(51) Int. Cl. G06F 19/00; G06N 7/00; G06F 19/22; G06N 99/00

(52) U.S. Cl. CPC G06F 19/345; G06N 99/005; G06N 7/005; G06F 19/22

(57) ABSTRACT

The disclosure is directed a computer implemented method for determining the likelihood of recurrence of a disease.

### CROSS-REFERENCE TO RELATED APPLICATIONS

This application claims priority to U.S. Provisional Application No. 62/252,827 that was filed on Nov. 9, 2015. The entire content of the application referenced above is hereby incorporated by referenced herein.

### FIELD

The present disclosure describes a method for determining the likelihood of disease recurrence.

### BACKGROUND

A plurality of factors and features may be used to predict a likelihood of disease recurrence. Applicant has identified a number of deficiencies and problems associated with assessing the risk of disease recurrence. Through applied effort, ingenuity, and innovation, many of these identified problems have been solved by developing solutions that are included in embodiments of the present invention, many examples of which are described in detail herein.

### BRIEF SUMMARY

This specification relates to determining a programmatically expected disease recurrence likelihood. In some implementations, the likelihood is determined based on a unique set of genes identified by the inventors. In one implementation, the set of genes is determined based on a protein interaction score associated with each gene from a set of genes. In some implementations, weights are assigned to each gene from the set of genes. In one implementation, the gene set may be reduced according to a machine learned algorithm. In one implementation, the weights may be assigned according to a machine learned algorithm. A final score specifying a programmatically expected disease recurrence likelihood may be determined based on weights associated with genes that are determined to be mutated.

Particular embodiments of the subject matter described herein can be implemented so as to realize one or more of the following advantages. Allow for providing a risk estimate of disease recurrence that is quantitative and individualized. In turn, estimates can be used to guide management of patients. Provide a more accurate estimate that allows for determination of whether a patient needs further treatments, such as, chemotherapy, radiation or other means of available therapies. Eliminate unnecessary and toxic treatment of patients that are unlikely to have recurrence of a disease.

The details of one or more embodiments of the subject matter described herein are set forth in the accompanying drawings and the description below. Other features, aspects, and advantages of the subject matter will become apparent from the description, the drawings, and the claims.

### BRIEF DESCRIPTION OF THE DRAWINGS

Having thus described the invention in general terms, reference will now be made to the accompanying drawings, which are not necessarily drawn to scale, and wherein:

FIG. 1 is an overview of a system that can be used to practice embodiments of the present invention;

FIG. 2 is an exemplary schematic diagram of a management computing entity according to one embodiment of the present invention;

FIG. 3 is an exemplary schematic diagram of a user computing entity according to one embodiment of the present invention;

FIGS. 4, 5A and 5B are flow charts illustrating various exemplary procedures and operations that may be completed in accordance with various embodiments of the present invention;

FIG. 6A illustrates exemplary levels of performance associated with various algorithms for predicting disease recurrence;

FIG. 6B illustrates an exemplary set of genes that may be used to predict disease recurrence;

FIG. 7 illustrates exemplary levels of performance associated with various gene sets for predicting a programmatically expected likelihood of disease recurrence;

FIG. 8 illustrates an exemplary graphical representation of levels of performance associated with various gene sets for predicting a programmatically expected likelihood of disease recurrence;

FIG. 9 illustrates exemplary levels of performance associated with a particular gene set for predicting a programmatically expected likelihood of disease recurrence; and

FIG. 10 illustrates an exemplary gene set and associated weights for predicting a programmatically expected likelihood of disease recurrence according to embodiments of the invention.

### DETAILED DESCRIPTION OF VARIOUS EMBODIMENTS

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### I. COMPUTER PROGRAM PRODUCTS, METHODS, AND COMPUTING ETITIES

Embodiments of the present invention may be implemented in various ways, including as computer program products that comprise articles of manufacture. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### II. EXEMPLARY SYSTEM ARCHITECTURE

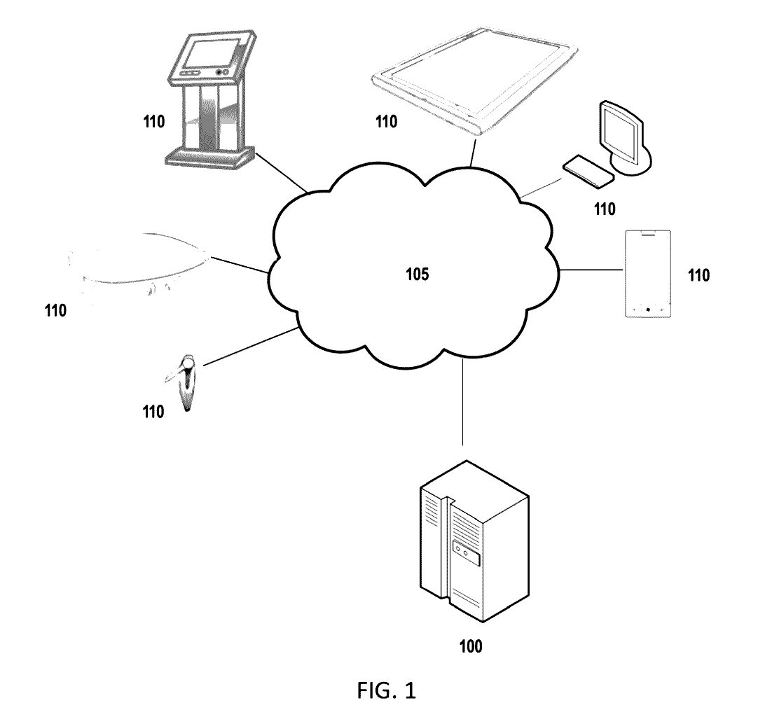

FIG. 1 provides an illustration of an exemplary embodiment of the present invention. As shown in FIG. 1, this particular embodiment may include one or more predictive computing entities 100, one or more networks 105, and one or more user computing entities 110. Each of these components, entities, devices, systems, and similar words used herein interchangeably may be in direct or indirect communication with, for example, one another over the same or different wired or wireless networks. Additionally, while FIG. 1 illustrates the various system entities as separate, standalone entities, the various embodiments are not limited to this particular architecture.

### 1. Exemplary Predictive Computing Entity

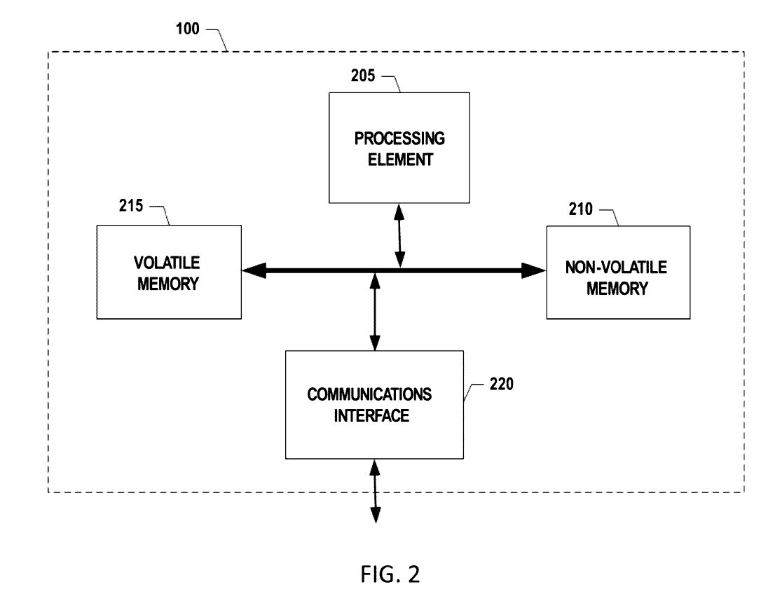

FIG. 2 provides a schematic of a predictive computing entity 100 according to one embodiment of the present invention. A predictive computing entity 100 may belong to, a medical facility, hospital, clinic, diagnostic service, and/or the like. However, the predictive computing entity 100 may belong a third party computing service that performs remote computations for a medical facility. In general, the terms computing entity, computer, entity, device, system, and/or similar words used herein interchangeably may refer to, for example, one or more computers, computing entities, desktop computers, mobile phones, tablets, phablets, notebooks, laptops, distributed systems, gaming consoles (e.g., Xbox, Play Station, Wii), watches, glasses, iBeacons, proximity beacons, key fobs, radio frequency identification (RFID) tags, ear pieces, scanners, televisions, dongles, cameras, wristbands, wearable items/devices, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the predictive computing entity 100 may also include one or more communications interfaces 220 for communicating with various computing entities, such as by communicating data, content, information, and/or similar terms used herein interchangeably that can be transmitted, received, operated on, processed, displayed, stored, and/or the like. For instance, the predictive computing entity 100 may communicate with user computing entities 110 and/or a variety of other computing entities.

As shown in FIG. 2, in one embodiment, the predictive computing entity 100 may include or be in communication with one or more processing elements 205 (also referred to as processors, processing circuitry, and/or similar terms used herein interchangeably) that communicate with other elements within the predictive computing entity 100 via a bus, for example. As will be understood, the processing element 205 may be embodied in a number of different ways. For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the predictive computing entity 100 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 210, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the predictive computing entity 100 may further include or be in communication with volatile media (also referred to as volatile storage, memory, memory storage, memory circuitry and/or similar terms used herein interchangeably). In one embodiment, the volatile storage or memory may also include one or more volatile storage or memory media 215, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the predictive computing entity 100 with the assistance of the processing element 205 and operating system.

As indicated, in one embodiment, the predictive computing entity 100 may also include one or more communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the predictive computing entity 100 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra wideband (UWB), infrared (IR) protocols, near field communication (NFC) protocols, Wibree, Bluetooth protocols, wireless universal serial bus (USB) protocols, and/or any other wireless protocol.

Although not shown, the predictive computing entity 100 may include or be in communication with one or more input elements, such as a keyboard input, a mouse input, a touch screen/display input, motion input, movement input, audio input, pointing device input, joystick input, keypad input, and/or the like. The predictive computing entity 100 may also include or be in communication with one or more output elements (not shown), such as audio output, video output, screen/display output, motion output, movement output, and/or the like.

As will be appreciated, one or more of the predictive computing entity's 100 components may be located remotely from other predictive computing entity 100 components, such as in a distributed system. Furthermore, one or more of the components may be combined and additional components performing functions described herein may be included in the predictive computing entity 100. Thus, the predictive computing entity 100 can be adapted to accommodate a variety of needs and circumstances. As will be recognized, these architectures and descriptions are provided for exemplary purposes only and are not limiting to the various embodiments.

### 2. Exemplary User Computing Entity

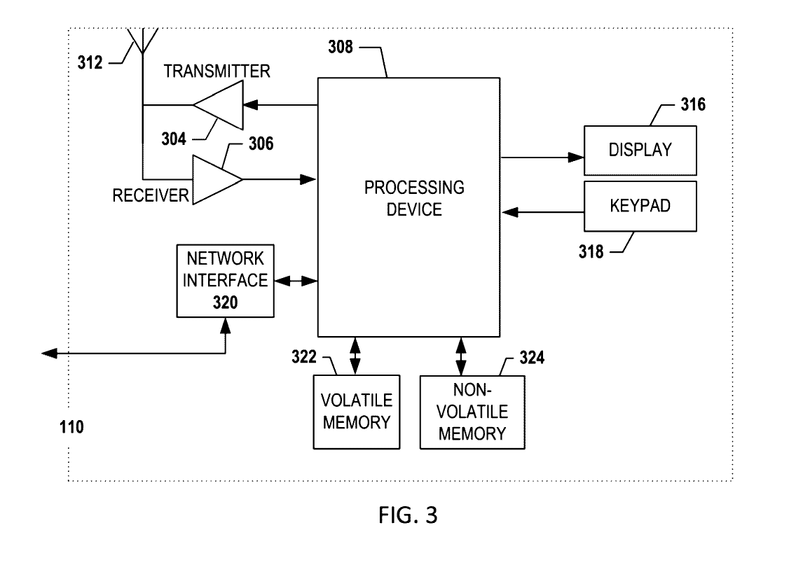

A user may be an individual, a family, a company, an organization, an entity, a department within an organization, a representative of an organization and/or person, and/or the like. In one example, users may be medical personnel, doctors, nurses, patients, and/or the like. For instance, a user may operate a user computing entity 110 that includes one or more components that are functionally similar to those of the predictive computing entity 100. FIG. 3 provides an illustrative schematic representative of a user computing entity 110 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, gaming consoles (e.g., Xbox, Play Station, Wii), watches, glasses, key fobs, radio frequency identification (RFID) tags, ear pieces, scanners, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. User computing entities 110 can be operated by various parties. As shown in FIG. 3, the user computing entity 110 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, respectively.

The signals provided to and received from the transmitter 304 and the receiver 306, respectively, may include signaling information in accordance with air interface standards of applicable wireless systems. In this regard, the user computing entity 110 may be capable of operating with one or more air interface standards, communication protocols, modulation types, and access types. More particularly, the user computing entity 110 may operate in accordance with any of a number of wireless communication standards and protocols, such as those described above with regard to the predictive computing entity 100. In a particular embodiment, the user computing entity 110 may operate in accordance with multiple wireless communication standards and protocols, such as UMTS, CDMA2000, 1×RTT, WCDMA, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the user computing entity 110 may operate in accordance with multiple wired communication standards and protocols, such as those described above with regard to the predictive computing entity 100 via a network interface 320.

Via these communication standards and protocols, the user computing entity 110 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The user computing entity 110 can also download changes, add-ons, and updates, for instance, to its firmware, software (e.g., including executable instructions, applications, program modules), and operating system.

According to one embodiment, the user computing entity 110 may include location determining aspects, devices, modules, functionalities, and/or similar words used herein interchangeably. For example, the user computing entity 110 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites. The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. Alternatively, the location information can be determined by triangulating the user computing entity's 110 position in connection with a variety of other systems, including cellular towers, Wi-Fi access points, and/or the like. Similarly, the user computing entity 110 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The user computing entity 110 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the user computing entity 110 to interact with and/or cause display of information from the predictive computing entity 100, as described herein. The user input interface can comprise any of a number of devices or interfaces allowing the user computing entity 110 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the user computing entity 110 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The user computing entity 110 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the user computing entity 110. As indicated, this may include a user application that is resident on the entity or accessible through a browser or other user interface for communicating with the predictive computing entity 100 and/or various other computing entities.

In another embodiment, the user computing entity 110 may include one or more components or functionality that are the same or similar to those of the predictive computing entity 100, as described in greater detail above. As will be recognized, these architectures and descriptions are provided for exemplary purposes only and are not limiting to the various embodiments.

### III. EXEMPLARY SYSTEM OPERATION

According to various embodiments, the predictive computing entity 100 and/or user computing entity 110 provides and/or aids in the access of programmatically expected predictions for disease recurrence (e.g., via a user interface). The user interface may be accessible from a user computing entity 110 (e.g., in communication with the predictive computing entity 100 via the network 105). For example, in various embodiments, a user may log in to the predictive computing entity 100 from a user computing entity 110 (e.g., by opening a log-in page and entering a user ID and password using display 316 and keypad 318). The predictive computing entity 100 may be configured to recognize any such log-in request, verify that user has permission to access the system (e.g., by confirming the user ID and password are valid), and present/provide the user with a user interface (e.g., displayed on display 316). In other embodiments, user log-in is not required to access the user interface.

In one example, a method for evaluating the risk of endometrial cancer recurrence after an initial treatment (e.g., surgery) is provided. In one embodiment, the method comprises several of the following steps including (1) collection of a portion of tumor specimen and a normal tissue (or blood) from an endometrial cancer patient; (2) extraction of DNA from both specimens; (3) next generation sequencing to detect genetic mutations; (4) genetic analysis to determine the genetic mutations; (5) selection of the set of genes which are mutated and determined to be predictive in the cancer patient; (6) assignment of different prediction weights to these genes; and (7) computation of the likelihood of cancer recurrence. The likelihood may be quantitative and individualized because the profile of genetic mutations is unique in each patient. In one implementation, the likelihood may be used to guide the management of patients for the purpose of determining whether the patient should receive additional treatment(s) (e.g., chemotherapy, radiation and/or the like). This allows for avoiding unnecessary and toxic treatment of patients that are unlikely to experience a recurrence of the disease. Similarly, this allows for providing additional treatment(s) to patients that are more likely to experience recurrence of the disease. Embodiments of the invention provide clinical decision support to help physicians and patients select the best treatment options for individual patients based on their associated risk or likelihood of recurrence. For example, embodiments of the invention may be used by physicians and patients to determine an accurate estimate of the risk or likelihood of cancer recurrence after an initial treatment (e.g., surgery). In one example, embodiments of the invention may be used by pharmaceutical companies to select specific risk groups for testing the efficacy of an intervention in preventing cancer recurrence and improving outcomes in general.

The Cancer Genome Atlas project has conducted whole exome sequencing data on endometrial tumors and reported somatic mutation in more than 20,000 unique genes. This data can be found at the Cancer Genome Atlas—Data Portal (https://tcgadata.nci.nih.gov/tcga/) which is here by incorporated in its entirety by reference. Clinical data includes 435 patients who have follow-up information including cancer recurrence status and other clinical features. The common data set where patients have both exome sequencing data and recurrence information include 240 patients with 34 recurrent cases. The recurrent cases were given a label of 1 and the non-recurrent cases 0 for the training purpose. In one implementation, the entire somatic mutation data set was used to train 14 common machine learning algorithms for prediction of recurrence. The machine learning algorithms include Naïve Bayes, Decision Tree, Radial Basis Function Networks, Random Forest, IBk, SMO, AdaBoostM1, MultiBoostAB, LogitBoost, Vote, MultiScheme, Stacking, Grading and CVParameterSelection. Ten-fold cross validation was used for all training purposes. Performance evaluation was expressed with AUC values (the area under a receiver operating characteristic ROC curve) to predict recurrence.

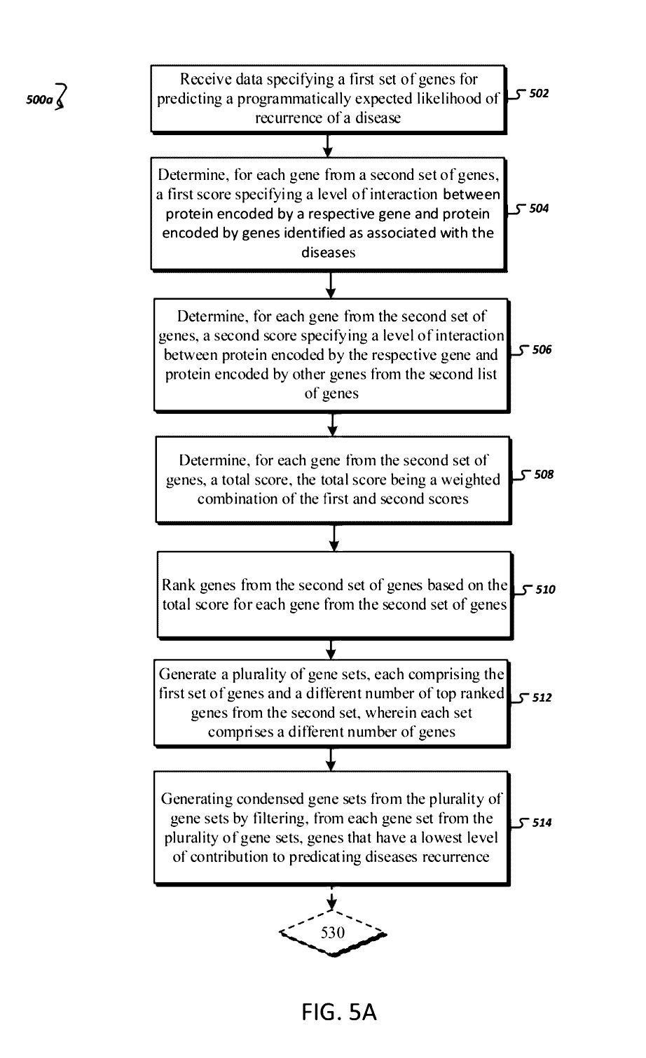

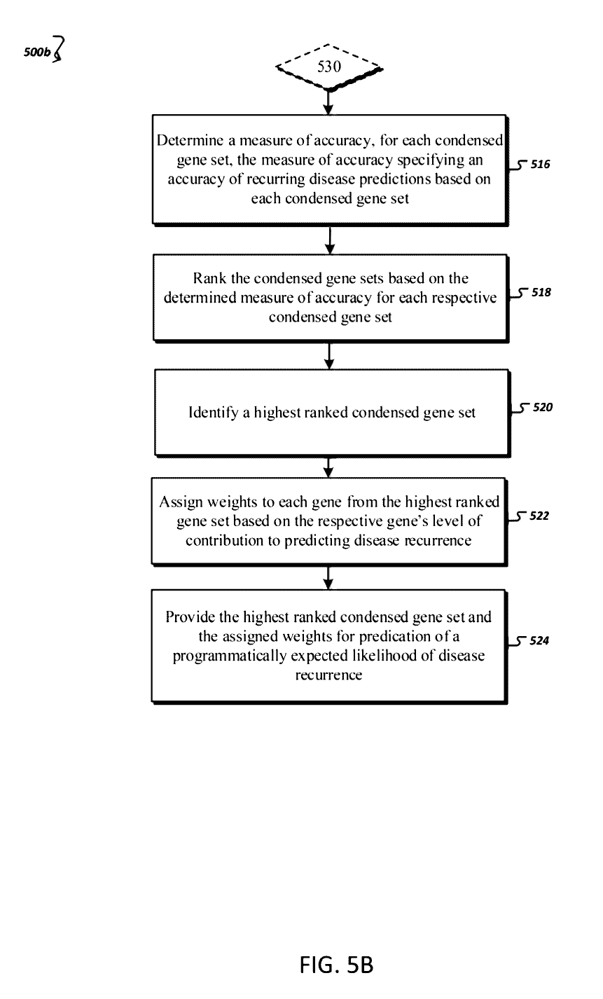

FIG. 6A illustrates the accuracy of predictions by the 14 algorithms based on all genetic mutations. For these examples, all 20404 unique genes that are mutated in endometrial cancer are used as predictive features or attributes for the machine learning algorithms. The learning process is computationally taxing with such high dimensions, especially when the number of attributes (20404) is much larger than the sample size (240). There are on average 700 unique genes are mutated per patient, making the design matrix very sparse. Thus far, the large dimensionality has prevented an accurate prediction of clinical outcomes. The AUC values are within a range of 0.459 to 0.594. This correlates to very poor performances. Accordingly, the inventors have determined that the use of all mutated genes for predictions does not provide accurate predictions.

FIGS. 5A and 5B are flow charts illustrating an exemplary processes 500a and 500b for determining a predictive set of genes in accordance with embodiments of the invention. Process 500a begins with receiving data specifying a first set of genes for predicting a programmatically expected likelihood of recurrence of a disease (502). For example, predictive computing entity 100 may receive a list of genes associated with a disease. For example, predicative computing entity 100 may receive a list of genes associated with endometrial cancer. Those skilled in the art will appreciate that FIG. 6B illustrates an exemplary set of genes associated with endometrial cancer. The inventors have realized that the current sets of endometrial cancer provide predictions that are lacking or not accurate.

Protein is the basic unit of cell functions actions. A complex consisting of multiple proteins is needed for most cellular functions. A phenotype, such as cell multiplication, motility and programmed cell death, is achieved through a signaling transduction pathway (a cascade of protein activation). All these activities are completed through protein to protein interaction. Accordingly, the inventors have determined that an active interacting protein may be indicative of its importance in cellular function. Therefore, genes may be identified as associated with a particular disease based on a measure of protein interactions associated with the genes.

Process 500a may continue with determining for each gene from a second set of genes, a first score specifying a level of interaction between protein encoded by a respective gene and protein encoded by genes identified as associated with the diseases (504). For example, the first score may be a DNS score specifying a level of interaction between protein encoded by a particular gene and protein encoded by endometrial cancer genes (e.g., genes from FIG. 6B). In one implementation, the second set is all genes. In one implementation, the second set is a proper subset of all the genes.

In one implementation, those skilled in the art will appreciate that an interaction score between 0 and 1 may be defined according to the following:

a: determines an initial slope of the curve,

$$x = {\sum }_{i} {d}_{i} {e}_{i} + \frac{n}{10}$$

d: reflects a size of the experiment. (e.g., 1 for small scale if reports 50 or less interactions and 0.5 for large scale experiments with >50 interactions.)

e: specifies an interaction level (e.g., e=1 for direct interaction and e=0.5 for no strong evidence of direct interaction.)

n: specifies a number of different publications supporting the interaction.

The process 500a may continue with determining, for each gene from the second set of genes, a second score specifying a level of interaction between protein encoded by the respective gene and protein encoded by other genes from the second list of genes (506). For example, the second score may be a TWS score specifying a level of interaction between protein encoded by a particular gene and protein encoded by other genes from the second list. In one implementation, the TWS score may be calculated according to the interaction score above.

The process 500a may continue with determining, for each gene from the second set of genes, a total score, the total score being a weighted combination of the first and second scores (508). For example, the total score may be the combined score of 90% of the first score and 10% of the second score. In one implementation, the total score is the combined score of 90% of the DNS score and 10% of the TWS score. In one implementation, the total score is the combined score of 80% of the DNS score and 20% of the TWS score. In turn, the process 500a may continue with ranking genes from the second set of genes based on the total score for each gene from the second set of genes (510). For example, the process 500a may rank the genes according to the total score described above.

The process 500a may then continue with generating a plurality of gene sets, each comprising the first set of genes and a different number of top ranked genes from the second set, wherein each set comprises a different number of genes (512). For example, prediction computing entity 100 may generating two new sets of genes. The first new set being a set including the genes from FIG. 6B and the top ranked 5 genes from the second set. The second new set being a set including the genes from FIG. 6B and the top ranked 20 genes from the second set.

In one implementation, using the endometrial cancer genes from FIG. 6B, the process 500a may incrementally add 10 genes having the highest total scores to create a subsequent lists. For example, the first list (List 0) may include the genes of FIG. 6B. The second list (List 1) may include the genes of FIG. 6B and the highest ranked 10 genes. In a different implementation, the second list (List 1) may include the genes of FIG. 6B and the highest ranked 20 genes. In one implementation, 61 lists are created (List 0-List 60) each list including 10 more genes (or approximately 10 more genes) than the previous list.

The process 500a continues with generating condensed gene sets from the plurality of gene sets by filtering, from each gene set from the plurality of gene sets, genes that have a lowest level of contribution to predicating diseases recurrence (514). In one implementation a machine learned algorithm may be used to condense the gene sets. For example, a lasso (least absolute shrinkage and selection operator) algorithm may be used. In one implementation, ridge regression methods may be used. The gene sets may be used as attributes for training a machine learning model.

It should be understood that the selection of attributes or genes for training machine learning models can greatly affect the respective performance. In some implementations, attributes and/or genes are selected based on statistical analysis. In some implementations, selection of the most significant attributes or genes is based on one or more different attribute selection approaches. These approaches may be (1) forward selection, which is starting with the most significant attributes and incrementally adding a next significant attribute until the model is stable; (2) backward elimination, which starts with all the attributes and exclude the non-significant attributes one by one until the model is stable; (3) a combination of forward selection and backward elimination; and (4) checking the significance of the attribute by statistical model (regression). In one embodiment, each attribute selection approach may give a subset of significant attributes. The attributes that are not shown to be significant by one or more of the attribute selection approaches may be excluded from the model.

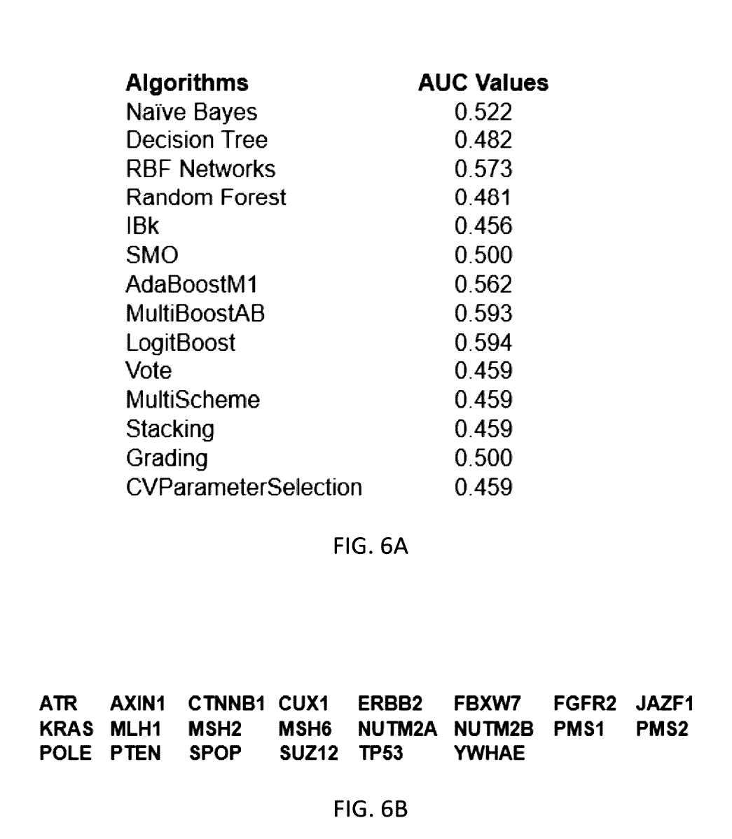

In some implementations, the process 500a optionally continue with the process 500b. In one implementation, the process 500a continues with determining a measure of accuracy, for each condensed gene set, the measure of accuracy specifying an accuracy of recurring disease predictions based on each condensed gene set (516). For example, the accuracy may be determined based on the data discussed above. In one implementation, the accuracy is determined for each list from the 61 lists. FIG. 7 illustrates various metrics, including accuracy metrics, associated with programmatically expected predictions based on each of the 61 lists.

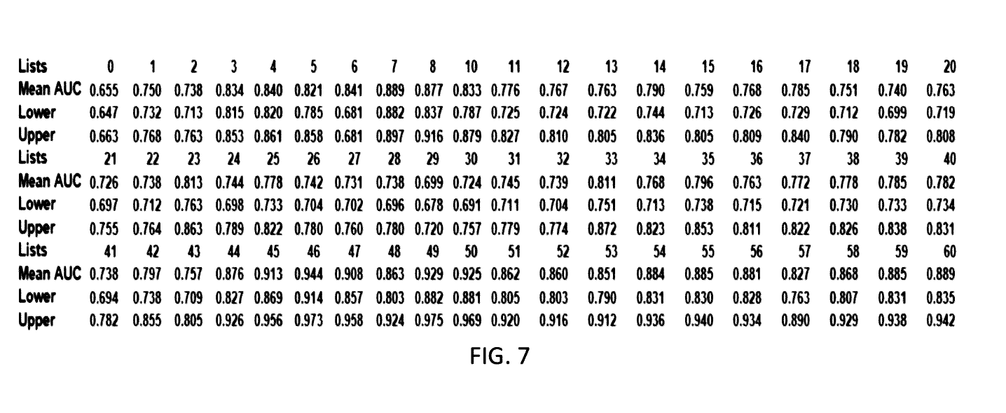

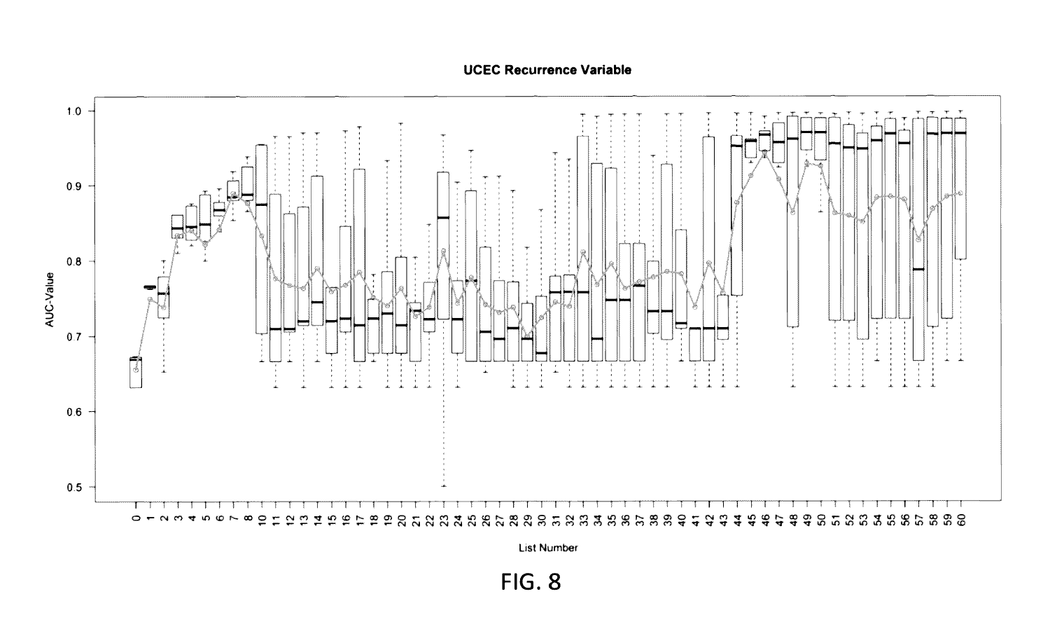

The process 500b may continue with, ranking the condensed gene sets based on the determined measure of accuracy for each respective condensed gene set (518). For example, the process 500b may rank each of the 61 lists according to a measure of accuracy associated with each. In turn, the process 500b identifies the highest ranked condensed gene set (520). FIG. 8 shows a graphical representation of the accuracy of programmatically expected predictions based on each of the 61 lists. According to FIGS. 7 and 8 list 46 is associated with the highest accuracy of programmatically expected predictions and is the highest ranked condensed gene set. FIG. 9 provides accuracy measurements for list 46 based on 25 repeated tests, each being with 10-fold cross validation.

The process 500b may continue with Assigning weights to each gene from the highest ranked gene set based on the respective gene's level of contribution to predicting disease recurrence (522). For examples, the weights may be assigned according to a machine learned algorithm as described above.

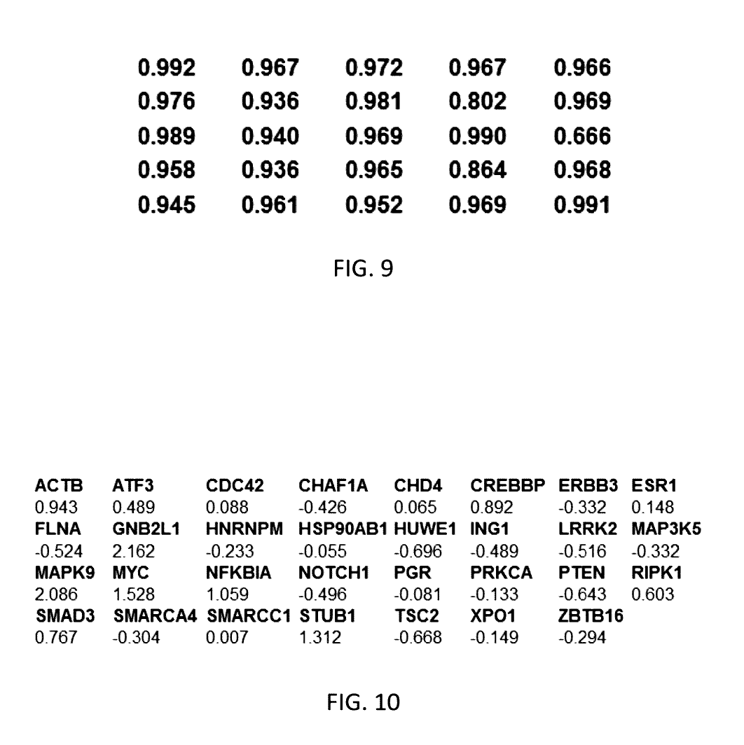

Finally the process 500b may end with providing the highest ranked condensed gene set and the assigned weights for predication of a programmatically expected likelihood of disease recurrence (524). For example, the process 500b may end with providing data similar to the data of FIG. 10. FIG. 10 depicts an exemplary condensed gene list and associated weights for predicting likelihood of disease recurrence.

Programmatically expected likelihood of disease recurrence may be determined according to the data of FIG. 10. For example, once a patient is admitted for a surgery, a tumor may be excised and used to extract DNA which will be subject to sequencing, such as next generation sequencing or traditional sequencing analysis after PCR amplification of target genes. Sequencing data may be processed through a cancer genome pipeline. Many genetic mutations may be identified after comparing sequencing results from the tumor tissue to the sequencing result from the normal tissue. The mutations may then be compared to the data from FIG. 10 and a final score is calculated based on the weights associated with genes from FIG. 10.

In one implementation, if the risk score is more than 0.5 then the patient is predicted to be more likely to have recurrence in the future. Higher risk values suggests a higher probability of disease recurrence. An oncologist can use this information to make a recommendations indicating whether radiation or chemotherapy is recommended.

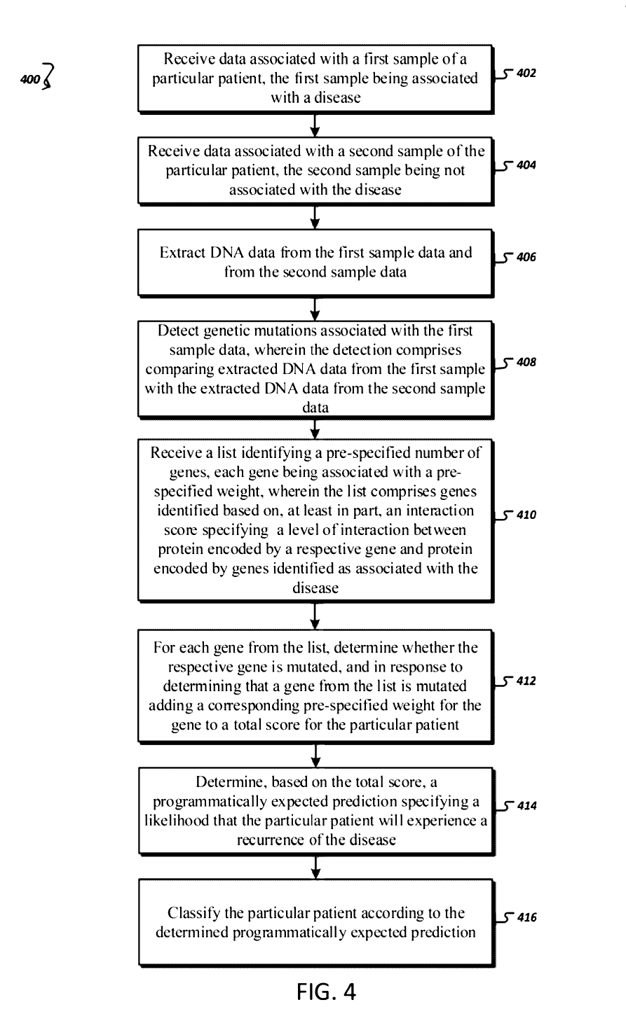

FIG. 4 illustrates an exemplary process 400 for determining a programmatically expected likelihood of disease recurrence according to embodiments of the invention. The process 400 may begin with receiving data associated with a first sample of a particular patient, the first sample being associated with a disease (402). For example, the first sample may be a tumor sample associated with endometrial cancer. The process 400 then may continue with receiving data associated with a second sample of the particular patient, the second sample being not associated with the disease (404). For example, the second sample may be a sample associated with a healthy tissue. The process 400 may continue with extracting DNA data from the first sample data and from the second sample data (406). For example, DNA and/or RNA data may be extracted from the tumor and the healthy tissue.

In turn, the process 400 detects genetic mutations associated with the first sample data, wherein the detection comprises comparing extracted DNA data from the first sample with the extracted DNA data from the second sample data (408). For example, the prediction computing entity 100 may identify mutated genes based on a comparison between the DNA and/or RNA data from the tumor tissue with the DNA and/or RNA data from the healthy tissue.

The process 400 may continue with receiving a list identifying a pre-specified number of genes, each gene being associated with a pre-specified weight, wherein the list comprises genes identified based on, at least in part, an interaction score specifying a level of interaction between protein encoded by a respective gene and protein encoded by genes identified as associated with the disease (410). For example, the prediction computing entity 100 may receive the data of FIG. 10.

In turn, for each gene from the list, the process 400 determines whether the respective gene is mutated, and in response to determining that a gene from the list is mutated adding a corresponding pre-specified weight for the gene to a total score for the particular patient (412). For example, with reference to FIG. 10, responsive to determining that the ACTB gene is mutated a value of 0.943 may be added to the total score. Similarly, if gene XPO1 is found to be mutated, a value of −0.149 is added to the total score (total score=0.943-0.149=0.794). This is repeated for each gene from FIG. 10.

The process 400 continues with determining, based on the total score, a programmatically expected prediction specifying a likelihood that the particular patient will experience a recurrence of the disease (414). For example the total score may be 0.8. In some implementations, the total sore is normalized. In other implementations, the total score is not normalized.

Finally the process 400 may end with classifying the particular patient according to the determined programmatically expected prediction. For example, if the total score is meets or exceeds 0.5, a programmatically expected prediction of disease recurrence is predicted for a corresponding consumer. However, if the score is below 0.5 the corresponding patient is not expected to experience disease recurrence. In some implementation, a threshold of 0.5 is used as described above. In other implementations a different threshold (e.g., 0.1, 0.3, and 0.4) may be used.

### IV. CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A computer implemented method comprising:
receiving data associated with a first sample of a particular patient, the first sample being associated with a disease;
receiving data associated with a second sample of the particular patient, the second sample being not associated with the disease;
extracting DNA data from the first sample data and from the second sample data; detecting genetic mutations associated with the first sample data, wherein the detection comprises comparing extracted DNA data from the first sample with the extracted DNA data from the second sample data;
receiving a list identifying a pre-specified number of genes, each gene being associated with a pre-specified weight, wherein the list comprises genes identified based on, at least in part, an interaction score specifying a level of interaction between protein encoded by a respective gene and protein encoded by genes identified as associated with the disease;
for each gene from the list, determining whether the respective gene is mutated, and in response to determining that a gene from the list is mutated adding a corresponding pre-specified weight for the gene to a total score for the particular patient; and
determining, based on the total score, a programmatically expected prediction specifying a likelihood that the particular patient will experience a recurrence of the disease; and classifying the particular patient according to the determined programmatically expected prediction.

2. The method of claim 1, wherein the disease is endometrial cancer.

3. The method of claim 1, wherein the list comprises at least one gene selected from a group comprising the following genes: ACTB, ATF3, CDC42, CHAF1A, CHD4, CREBBP, ERBB3, ESR1, FLNA, GNB2L1, HNRNPM, HSP90AB1, HUWE1, ING1, LRRK2, MAP3K5, MAPK9, MYC, NFKBIA, NOTCH1, PGR, PRKCA, PTEN, RIPK1, SMAD3, SMARCA4, SMARCC1, STUB1, TSC2, XPO1, and ZBTB16 genes.

4. The method of claim 1, wherein the weights are assigned to genes based on a machine learned algorithm.

5. The method of claim 4, wherein the machine learned algorithm is a least absolute shrinkage and selection operator algorithm.

6. The method of claim 4, wherein the machine learned algorithm is a regression algorithm.

7. A computer implemented method comprising:
receiving data specifying a first set of genes for predicting a programmatically expected likelihood of recurrence of a disease;
determining, for each gene from a second set of genes, a first score specifying a level of interaction between protein encoded by a respective gene and protein encoded by genes identified as associated with the disease;
determining, for each gene from the second set of genes, a second score specifying a level of interaction between protein encoded by the respective gene and protein encoded by other genes from the second list of genes;
determining, for each gene from the second set of genes, a total score, the total score being a weighted combination of the first and second scores;
ranking genes from the second set of genes based on the total score for each gene from the second set of genes;
generating a plurality of gene sets, each comprising the first set of genes and a different number of top ranked genes from the second set, wherein each set comprises a different number of genes; and
generating condensed gene sets from the plurality of gene sets by filtering, from each gene set from the plurality of gene sets, genes that have a lowest level of contribution to predicating diseases recurrence.

8. The method of claim 7, further comprising:
determining a measure of accuracy, for each condensed gene set, the measure of accuracy specifying an accuracy of recurring disease predictions based on each condensed gene set;
ranking the condensed gene sets based on the determined measure of accuracy for each respective condensed gene set; and
determining a highest ranked condensed gene set.

9. The method of claim 8, further comprising assigning weights to each gene from the highest ranked gene set based on the respective gene's level of contribution to predicting disease recurrence.

10. The method of claim 9, wherein the weights are assigned based on a machine learned algorithm.

11. The method of claim 9, further comprising providing the highest ranked condensed gene set and the assigned weights for predication of a programmatically expected likelihood of disease recurrence.

12. The method of claim 10, wherein the machine learned algorithm is a least absolute shrinkage and selection operator algorithm.

13. The method of claim 10, wherein the machine learned algorithm is a regression algorithm.

14. The method of claim 9, wherein the disease is endometrial cancer.

15. The method of claim 9, wherein the highest ranked gene set comprises at least one gene selected from a group comprising: ACTB, ATF3, CDC42, CHAF1A, CHD4, CREBBP, ERBB3, ESR1, FLNA, GNB2L1, HNRNPM, HSP90AB1, HUWE1, ING1, LRRK2, MAP3K5, MAPK9, MYC, NFKBIA, NOTCH1, PGR, PRKCA, PTEN, RIPK1, SMAD3, SMARCA4, SMARCC1, STUB1, TSC2, XPO1, and ZBTB16 genes.
